(19) United States
(12) Patent Application Publication
(10) Pub. No.: US 2018/0254617 A1
(43) Pub. Date: Sep. 6, 2018

(54) WIRE PULLER AND METHOD OF PULLING WIRE

(71) Applicant: Shock Electric Co., Parma, OH (US)

(72) Inventor: Paul JOSEFIV, Parma, OH (US)

(21) Appl. No.: 15/450,608

(22) Filed: Mar. 6, 2017

(51) Int. Cl. H02G 1/08; B66D 1/74; B65H 75/30

(52) U.S. Cl. CPC H02G 1/081; B65H 75/305; B66D 1/7489

(57) ABSTRACT

Disclosed is a wire puller for pulling wire such as electrical wire. The wire puller includes substantially parallel first and second supports, at least one adjustable roller adjustably attached to the first and second supports, a capstan support attached to the first and second supports, a capstan attached to the capstan support, a hook support attached to the first support second supports, a hook engaged with the hood support, and a brace attached to the first and second supports. Also disclosed is a method of pulling a wire using the wire puller.

### TECHNICAL FIELD

The present disclosure relates to a wire pulling apparatus and method for pulling wires with the wire pulling apparatus.

### BACKGROUND

Many building structures utilize electrical wire and various types of cables to provide electricity, communications, and the like. These wires and cables are frequently installed in conduits, such as plastic or metal tubes. Conduits are often installed into the walls, ceiling, and floors of a building during construction of the building, and wires and cables are then installed into the conduits after the framework of the building is sufficiently complete.

In order to pull the electrical wire or other communication cables, a flexible cord, line, or rope is typically threaded through the conduit to extend out of both ends of the conduit. The electrical wire or other communications cables are then attached to an end of the pulling cord, line or rope, and the wire or cable is pulled through the conduit.

While it is relatively easy for a contractor to manually pull a cable or wire through a short straight section of conduit, it becomes increasingly difficult to pull a cable or wire through a longer conduit or a conduit that has bends, curves, turns and the like. Additionally, thicker, heavier wires and cables are more difficult to pull through conduit than thinner ones. Therefore, a point is reached where a person is simply not strong enough to manually pull the desired wire or cable through the desired length of conduit.

It is known to use wire pulling equipment that includes a motor-driven capstan about which the wire or rope to be pulled can be wound, a series of arms which are joined in an end-to-end arrangement so that as the wire or rope being pulled from the conduit moves toward the capstan, with the wire or rope being guided along the arrangement of arms. The free end of the arm arrangement is positioned against an end of the conduit, and the motor-driven capstan is actuated for pulling the wire or rope through and out of the conduit. Certain known methods and equipment for the pulling of cables or wires through a conduit may utilize a system of rollers or pulleys to aid in pulling a cable through a conduit while minimizing friction, as friction may damage both the cable and the conduit, as well as make the task of pulling a cable through a conduit more difficult.

### SUMMARY

Disclosed is a wire puller comprising first and second spaced-apart supports in a substantially parallel arrangement, at least one wire guide surface extending between said first and said second supports, at least one capstan support attached to at least one of said first and second supports, at least one capstan attached to said capstan support, at least one hook support extending between said first and second supports, at least one hook engaged with said hook support, and a brace attached to said first and second supports.

Also disclosed herein is a method of pulling a wire through a conduit using the wire puller. The method of pulling a wire through a conduit comprising providing a wire puller comprising first and second longitudinally extending supports positioned in a spaced-apart and substantially parallel arrangement, at least one wire guide surface extending between said first and said second supports, at least one capstan support attached to at least one of said first and second supports, at least one capstan attached to said capstan support, at least one hook support extending between said first and second supports, at least one hook engaged with said hook support and a brace attached to said first and second supports; bracing said wire puller on a wall surface above said conduit by contacting said brace with said wall surface; engaging a wire or a lead for a wire to said wire puller; and pulling a wire through said conduit.

### BRIEF DESCRIPTION OF DRAWINGS

The accompanying drawings are included to provide a further understanding of the apparatus and method provided herein, and are incorporated in and constitute a part of this specification. The drawings illustrate embodiments of the apparatus and method provided herein and, together with the description, serve to explain the principles described herein, but are not intended to limit the specification or any of the claims.

FIG. 1. is a front view of an illustrative embodiment of the wire puller.

FIG. 2 is a perspective view of an illustrative embodiment of the wire puller.

FIG. 3 is a side view of an illustrative embodiment of the wire puller engaged with a wall panel.

FIG. 4 is a perspective view of an illustrative embodiment of the wire puller pulling wire through the conduit from below.

FIG. 5 is a rear view of an illustrative embodiment of the capstan of the wire puller with a drill engaged with the capstan to operate it.

### DETAILED DESCRIPTION

Provided is a wire puller for pulling cables or wires. The wire puller is useful for pulling long continuous runs of electrical wire through conduit and other service penetrations. The wire puller includes first and second longitudinally extending supports. The first and second supports are positioned in a spaced-apart arrangement. According to certain illustrative embodiments, the first and second supports are positioned in a spaced-apart and substantially parallel arrangement. The spaced-apart first and second supports define a plane extending therebetween. When the wire puller is braced against a building wall for pulling cable or wire through a conduit, the plane has a surface facing toward the wall and an opposite surface facing way from the wall.

The wire puller includes at least one wire guide surface extending between the first and said second supports. According to certain illustrative embodiments, the wire puller includes more than one wire guide surface. According to certain illustrative embodiments, and without limitation, the wire guide surface comprises an adjustable roller. According to certain embodiments, the wire puller includes more than one adjustable roller acting as a wire guide surface. The adjustable roller may be adjustably connected between the first and second supports, such that the roller(s) extend from the first support to the second support within the plane define by the first and second supports. This adjustable connection of the roller(s) to the first and second supports permits user-defined movement of the adjustable rollers up and down along the longitudinal axis of the longitudinally extending first and second supports. The connection of the adjustable roller(s) to the first and second supports may also be a pivotable connection to permit the roller(s) to be pivotably moved in and out of the plane defined by the spaced-apart first and second supports, in addition to being able to move up and down along the longitudinal axis of the first and second supports within the plane defined by the first and second supports. Depending on the wire pulling operation being carried out with the wire puller, the adjustable roller may extend inwardly toward the conduit or outwardly away from the conduit relative to the plane defined by the substantially parallel first and second supports.

The wire puller further includes at least one capstan support attached to at least one of the first and second supports and a capstan attached to the capstan support. The capstan support may comprise any structure that is suitable for attaching, connecting, engaging, mounting, or supporting the capstan. By way of example, but not in limitation, the capstan support may comprise an arm, base, board, pane, panel, plate, mounting, sheet, substrate and the like. The capstan support is connected to at least one of the first and second supports. According to certain embodiments, the capstan support is connected to both of the first and second supports. The capstan may be driven or otherwise operated by manually by hand, by an integral electric motor, or external electrical motor that must be engaged with the capstan. According to some embodiments, the capstan is operated by a hand-held electric drill that is engaged with the capstan. The electric drill rotates the capstan to take up the cable or wire being pulled by successively winding the cable or wire around the capstan while the capstan is rotating.

The wire puller also includes a hook support. The hook support is attached to at least one of the first and second supports and extends between the spaced-apart first and second supports. According to certain illustrative embodiments, the hook support is attached to both of the first and second spaced-apart supports and extends the entire distance between the first and second supports. There is no limitation on the structure of the hook support accept that it must be capable of connection to at least of the first and second supports and must be capable of supporting at least one wire hook. For example, and without limitation, the hook support may comprise a round bar attached to both the first and second supports and extending the entire distance between the first and second supports. A slidable hook may be coaxially fitted over the exterior surface of the round bar to permit the hook to freely slide back and forth along at least a portion of the length of the round bar hook support extending between the spaced-apart first and second supports. According to certain illustrative embodiments, the slidable hook may be engaged with one or more pulleys to further assist in the wire pulling operation.

The wire puller further includes a brace member that is attached to at least one of the first and second supports. According to certain illustrative embodiments, the brace is attached to both of the first and second spaced-apart supports. According to other illustrative embodiments, the brace member includes integral connecting flanges or tabs for directly connecting to the first and second supports. According to other illustrative embodiments, the brace member is connected to the first and second supports with connector members. According to some embodiments, the brace is mounted on a wall above a conduit. The brace is positioned at the top of the wire puller and is adapted to engage a building wall at a position that is above an electrical conduit. The brace member is brought in contact with a building wall surface and is supported against a wall by the weight of the wire puller. The face of the brace member may include means for preventing slippage and/or electrical insulation. Such means include, without limitation, providing the face of the brace member with an anti-slip or electrically insulating member. Such members include neoprene, PEV, TEV, rubber, or synthetic rubber.

The first and second supports of the wire puller have opposite first and second ends. A first base member is attached to the first end of the first support, and a second base member is attached to the first end of the second support. These base members are pivotably attached to the first ends of the first and second supports. The base members are adapted to engage a support surface. The first and second base member may further include a surface that includes means for preventing slip on a surface. The means for preventing slippage against a surface, including but not limited to neoprene, PEV, TEV, rubber, or synthetic rubber.

According to certain embodiments the wire puller may further include provided a second brace member. The second brace member may be attached to at least one of the first and second supports. According to certain embodiments, the second brace member is attached to both of the first and second supports. The second brace is pivotably attached to the first and second supports to permit the second brace to pivot inwardly toward the electrical conduit. The second brace has a length that is sufficient to extend into the electrical conduit to engage the framework of the conduit or the back wall of an electrical panel positioned within the conduit to provide further support to the wire puller during the wire pulling operation. The combination of the first and second braces provide sufficient support for the wire puller against the wall during the wire pulling process, while at the same time, spacing the other components of the wire puller at a sufficient clearance or distance away from the electrical conduit such as the cable or wire being pulled is not impeded by other wire puller components.

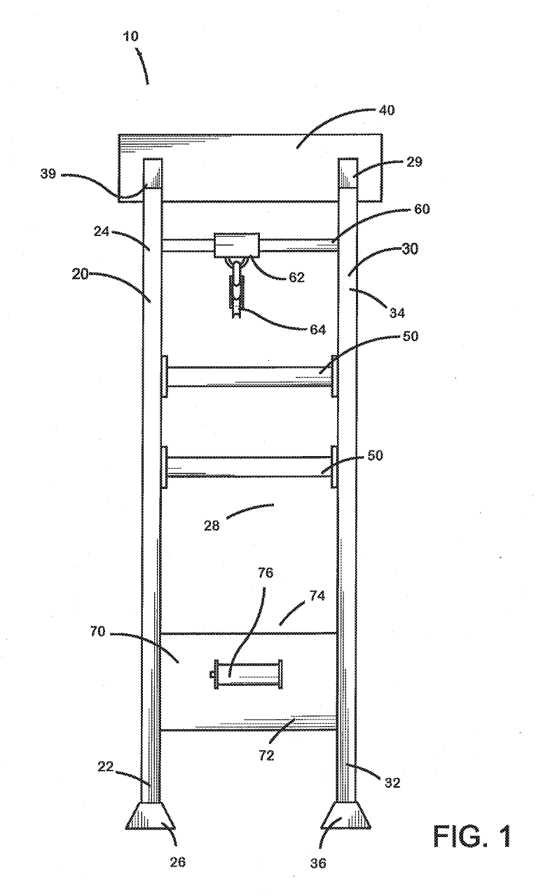

An illustrative embodiment of the wire puller is shown in FIG. 1. The wire puller 10 includes first 20 and second 30 longitudinally extending supports that are spaced-apart and substantially parallel. First longitudinally extending support 20 has opposite first 22 and second 24 ends. Second longitudinally extending support 30 also has opposite first 32 and second 34 ends. The first 20 and second 30 supports positioned in a spaced-apart and substantially parallel arrangement define an imaginary plane 28 extending between the supports 20, 30. A base member 26 is pivotably attached to the first end 22 of the first support 20. A base member 36 is pivotably attached to the first end 32 of the second support 30. A brace 40 is pivotably connected at the second ends 24, 34 of the first 20 and second 30 spaced-apart supports. Brace 40 includes opposite facing first 42 and second 44 face surfaces. Face surface 42 of brace 40 is configured or otherwise adapted to engage the surface of a vertically extending building wall when the wire puller 10 is in use. Face surface 44 of brace 40 faces away from the vertically extending building wall when brace 40 of the wire puller 10 is in contact with the building wall surface. Wire guide surfaces, provided as adjustable rollers 50, are attached to the spaced apart first 20 and second 30 supports, and extend the entire distance between the first 20 and said second 30 supports. The adjustable rollers 50 are upwardly and downwardly adjustable along the longitudinal axis of the supports 20, 30 within the imaginary plane 28 defined by the spaced-apart supports 20, 30. The rollers 50 are also pivotably adjustable outwardly of the plane 28 defined by the supports 20, 30. In the illustrative embodiments shown in FIG. 1, rollers 50 are adjustable to positions on both sides of the plane 28.

Still referring to FIG. 1, wire puller 10 includes a hook support 60. Hook support 60 is attached to first 20 and second 30 supports and extends in plane 28 defined by support 20, 30. A movable hook 62 is movably engaged with the hook support 60. Movable hook 62 is capable of sliding or otherwise translating along the entire length of the hook support 60 from first 20 to second 30 supports. A pulley 64 for engaging wire to be pulled is removably engaged with hook 62. The hook support 60 allows slidable motion of the slidable hook 62, which allows for more flexibility in the positioning of the pulling of a wire or cable through the conduit. Pulley 64 further aids in the wire pulling process. Wire puller 10 further includes a capstan support 70 that is attached to both first 20 and second 30 spaced-apart supports. The capstan support 70 has opposite facing first 72 and second 74 surfaces. Capstan 76 is mounted on first surface 72 of the capstan support 70.

Still referring to FIG. 1, according to some illustrative embodiments and without limitation, the brace 40 is positioned against a vertically extending building wall above an electrical conduit. Second ends 24, 34 of supports 20, 30 carry pivotably connected brace connectors 29, 39. Brace 40 is connected to first and second supports 20, 30 of the wire puller 10 by brace connectors 29, 39.

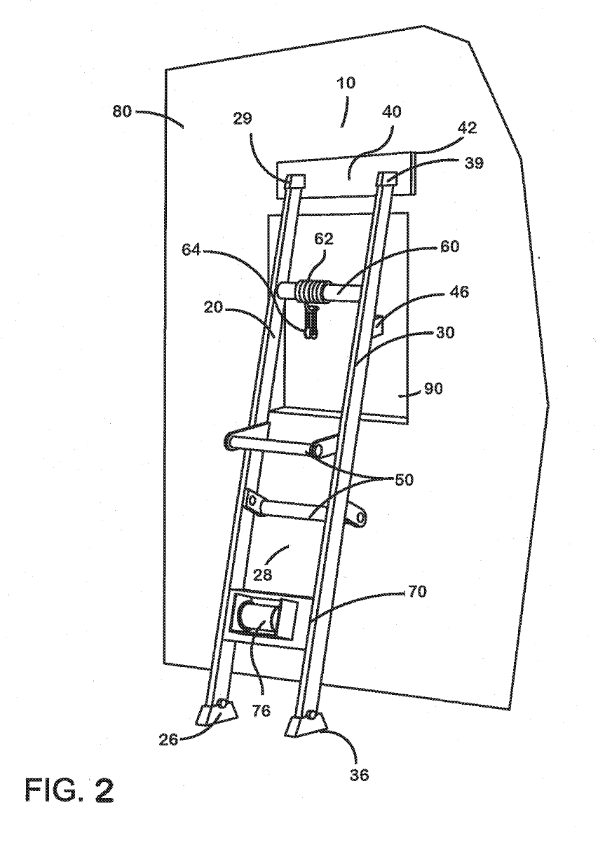

Turning to FIG. 2, a perspective view of an illustrative embodiment of the wire puller 10 is shown. The brace 40 of the wire puller 10 is engaged against a vertically extending building wall 80. The first face 42 of brace 40 of wire puller 10 is engaged with wall 80 at a position that is above the top edge of an electrical conduit 90 in the building wall 80. Brace 40 is connected to the first and second supports 20, 30 by the brace connectors 29, 39 at the second ends 24, 34 of the first and second supports 20, 30. Base members 26, 36 are pivotably connected at the first ends 22, 32 of first and second supports 20, 30 and are engaged with the floor 85 to provide support for the wire puller 10. Second brace 46 is connected to the first and second supports 20, 30 and extends into the electrical conduit 90 embedded in the building wall 80. The leading edge 48 of the second brace 46 engages the rear of the electrical conduit 90 to provide addition support and stability to the wire puller 10. The hook support 60 with sliding hook 62 and pulley 64 are engaged with the first and second supports 20, 30, and the wire puller 10 is braced against the wall 80. Wire puller 10 includes an adjustable roller 50 adjusted outwardly from the wall 80 and another roller 50 adjusted inwardly toward the wall 80. The capstan support 70 is mounted to the lower end of the first and second supports 20, 30. The capstan 76 is mounted on the capstan support 70.

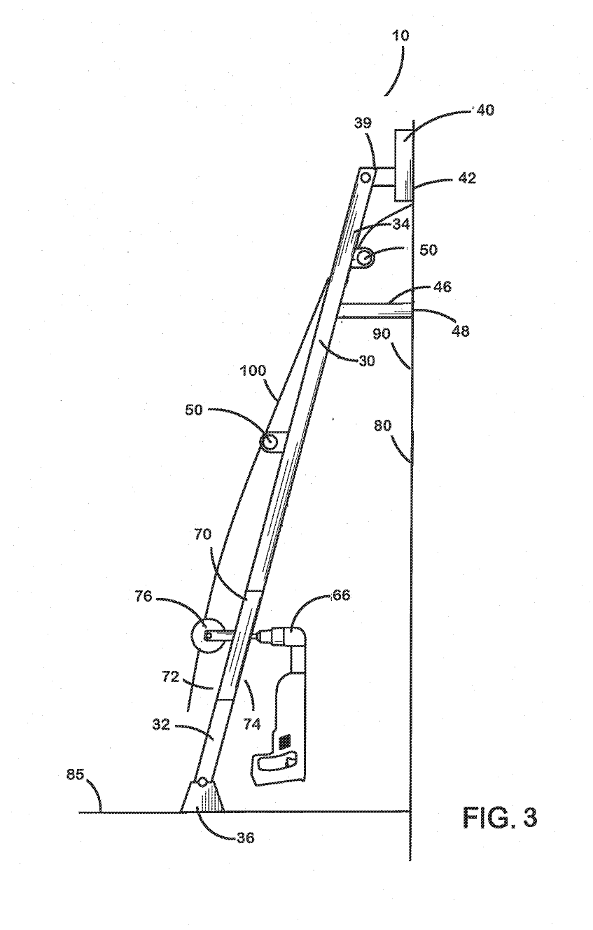

Turning to FIG. 3, a right side view of an illustrative embodiment of the wire puller 10 is shown. The first face surface 42 of brace 40 of the wire puller 10 is engaged against the vertically extending building wall 80. The first face 42 of brace 40 of wire puller 10 is engaged with wall 80 at a position that is above the top edge of an electrical conduit 90 in the building wall 80. Brace 40 is connected to the second support 30 by the brace connector 39 at the second end 34 of the second supports 30. Base member 36 is pivotably connected at the first end 32 of the second support 30 and is engaged with the floor 85 to provide support for the wire puller 10. Second brace 46 is connected to the second support 30 and extends into the electrical conduit 90 embedded in the building wall 80. The leading edge 48 of the second brace 46 engages the rear of the electrical conduit 90 to provide addition support and stability to the wire puller 10. Wire puller 10 includes a first adjustable roller 50 positioned near the top of the wire puller 10 and which is adjusted inwardly toward the wall 80 and another roller 50 positioned above the capstan 76 and which is adjusted outwardly from the wall 80. The capstan support 70 is mounted to the lower end of the second support 30. The capstan 76 is mounted on the capstan support 70. An hand-held electric drill 66 is engaged with the capstan 76 to rotate the capstan 76. The drill is stabilized by connecting to the first and/or second supports 20, 30, and/or to the capstan support 70 with one or more brackets 67. A wire 100 being pulled from an above location with the wire puller 10 exits the conduit 90 from above, travels over adjustable rollers 50, and is taken up by the winding of the rotating capstan 76.

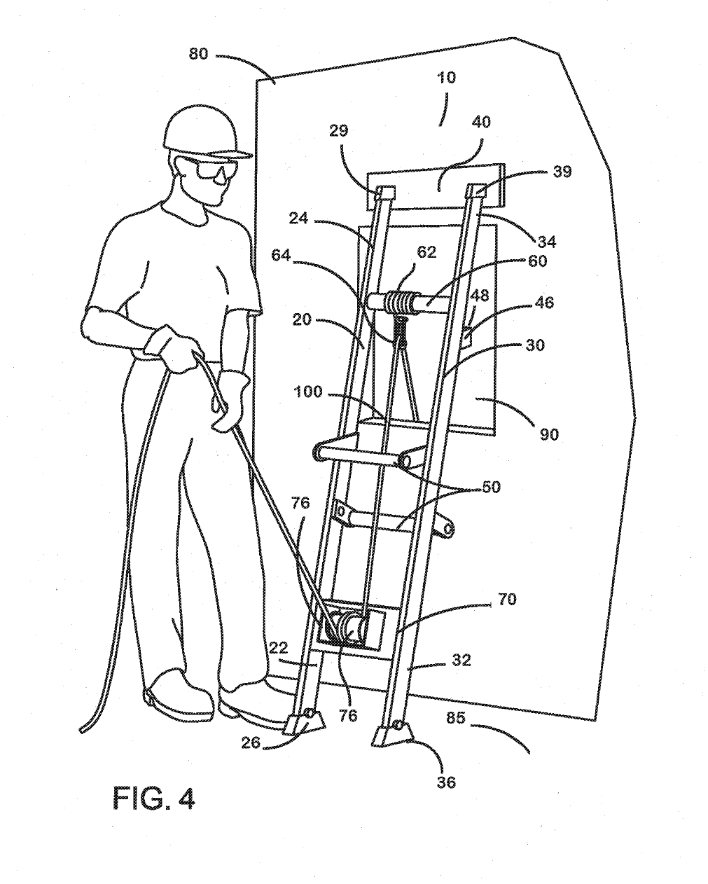

Turning now to FIG. 4, another perspective view of an illustrative embodiment of the wire puller 10 is shown. The brace 40 of the wire puller 10 is engaged against the vertically extending building wall 80. The brace 40 of wire puller 10 is engaged with wall 80 at a position that is above the top edge of an electrical conduit 90 in the building wall 80. Brace 40 is connected to the first 20 and second 30 supports by brace connectors 29, 39 at the second ends 24, 34 of the supports 20, 30. Base members 26, 36 are pivotably connected at the first ends 22, 32 of the first 20 and second 30 supports, and are engaged with the floor 85 to provide support for the wire puller 10. Second brace 46 is connected to the first 20 and second 30 supports and extend into the electrical conduit 90 embedded in the building wall 80. The leading edge 48 of the second brace 46 engages the rear of the electrical conduit 90 to provide addition support and stability to the wire puller 10. Wire puller 10 includes first and adjustable rollers 50 positioned below the hook support 60 of the wire puller 10 and which are alternatively adjusted inwardly toward the wall 80 and outwardly from the wall 80. The capstan support 70 is mounted to the lower end of the second support 30. The capstan 76 is mounted on the capstan support 70. A wire 100 being is pulled from a location below with the wire puller 10. Wire 100 exits the conduit 90 from below, engages the pulley 64 carried by the hook 62, turns downwardly, travels over adjustable rollers 50, and is taken up by the winding of the rotating capstan 76.

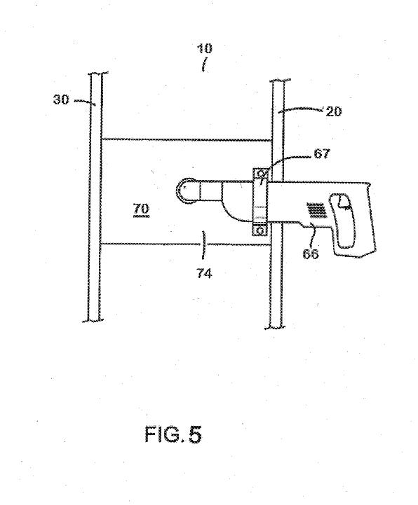

In particular and referring to FIG. 5, a rear view of a portion of an illustrative embodiment of the wire puller 10 is shown. The capstan support 70 is mounted to the spaced-apart first 20 and second 30 supports. A hand-held drill 66, which is be used to turn the capstan 76, is engaged with the capstan support 70 through bracket 67. FIG. 5 shows an illustrative embodiment utilizing a drill to rotate capstan 76, however, any means of rotating the capstan 76 known in the art may be used, including, without limitation, a hand crank, hydraulic motor, electric motor, or air-driven motor.

According to a first embodiment, the wire puller comprises first and second longitudinally extending supports positioned in a spaced-apart and substantially parallel arrangement, at least one wire guide surface extending between said first and said second supports, at least one capstan support attached to at least one of said first and second supports, at least one capstan attached to said capstan support, at least one hook support extending between said first and second supports, at least one hook engaged with said hook support and a brace attached to said first and second supports.

According to a second illustrative embodiment, each of said first and second supports have opposite first and second ends, wherein a first base member is attached to said first end of said first support, and wherein a second base member is attached to said first end of said second support.

The wire puller of the first or second embodiments above, wherein said first and second base members comprise means for preventing slip on a surface.

According to a fourth illustrative embodiment, the wire puller of any one of the first through third embodiments above, wherein each of said first and second supports have opposite first and second ends, wherein a first pivotable connector is attached to said second end of said first support, and wherein a second pivotable member is attached to said second end of said second support.

According to a fifth illustrative embodiment, the wire puller of any one of the first through fourth embodiments above, wherein said brace is pivotably attached to said first and second supports by said first and second connectors.

According to a sixth illustrative embodiment, the wire puller of any one of the first through fifth embodiments above, wherein said at least one wire guide surface comprises a roller adjustably attached to and extending between said first and second supports.

According to a seventh illustrative embodiment, the wire puller of any one of the first through sixth embodiments above, wherein said first and second supports define a plane, and wherein said roller is adjustable within said plane defined by said first and second spaced-apart supports.

According to an eighth illustrative embodiment, the wire puller of any one of the first through seventh embodiments above, wherein said first and second supports define a plane, and wherein said roller is adjustable to positions out of said plane defined by said first and second spaced-apart supports.

According to a ninth illustrative embodiment, the wire puller of any one of the first through eighth embodiments above, wherein said hook is slidably engaged to said hood support and is capable of sliding along at least a portion of said hook support extending between said first and second supports.

According to a tenth illustrative embodiment, the wire puller of any one of the first through ninth embodiments above, wherein said hook is slidably engaged to said hood support and is capable of sliding along the entire portion of said hook support extending between said first and second supports.

According to an eleventh illustrative embodiment, the wire puller of any one of the first through tenth embodiments above, wherein a pulley is engaged with said hook.

According to a twelfth illustrative embodiment, the wire puller of any one of the first through eleventh embodiments above, wherein said bracket is capable of pivoting outwardly from said plane defined by said first and second supports.

According to a thirteenth illustrative embodiment, the wire puller of any one of the first through twelfth embodiments above, wherein said capstan extends outwardly from said plane defined by said first and seconds support in a direction substantially opposite to said bracket.

According to a fourteenth illustrative embodiment, the wire puller of any one of the first through thirteenth embodiments above, wherein said capstan is configured to be operated by a drill.

While the wire pulling apparatus and method of pulling wire have been described in connection with various illustrative embodiments, it is to be understood that other similar embodiments may be used or modifications and additions may be made to the described embodiments for performing the same function. Furthermore, the various illustrative embodiments may be combined to produce the desired results. Therefore, the wire puller and pulling method should not be limited to any single embodiment, but rather construed in breadth and scope in accordance with the recitation of the appended claims. It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the disclosure may be combined to provide the desired result.

1. A wire puller comprising:
first and second longitudinally extending supports positioned in a spaced-apart and substantially parallel arrangement;
at least one wire guide surface extending between said first and said second supports;
at least one capstan support attached to at least one of said first and second supports;
at least one capstan attached to said capstan support;
at least one hook support extending between said first and second supports;
at least one hook engaged with said hook support; and
a brace attached to said first and second supports.

2. The wire puller of claim 1, wherein each of said first and second supports have opposite first and second ends, wherein a first base member is attached to said first end of said first support, and wherein a second base member is attached to said first end of said second support.

3. The wire puller of claim 2, wherein said first and second base members comprise means for preventing slip on a surface.

4. The wire puller of claim 1, wherein each of said first and second supports have opposite first and second ends, wherein a first pivotable connector is attached to said second end of said first support, and wherein a second pivotable member is attached to said second end of said second support.

5. The wire puller of claim 4, wherein said brace is pivotably attached to said first and second supports by said first and second connectors.

6. The wire puller of claim 1, wherein said at least one wire guide surface comprises a roller adjustably attached to and extending between said first and second supports.

7. The wire puller of claim 6, wherein said first and second supports define a plane, and wherein said roller is adjustable within said plane defined by said first and second spaced-apart supports.

8. The wire puller of claim 6, wherein said first and second supports define a plane, and wherein said roller is adjustable to positions out of said plane defined by said first and second spaced-apart supports.

9. The wire puller of claim 1, wherein said hook is slidably engaged to said hood support and is capable of sliding along at least a portion of said hook support extending between said first and second supports.

10. The wire puller of claim 1, wherein said hook is slidably engaged to said hood support and is capable of sliding along the entire portion of said hook support extending between said first and second supports.

11. The wire puller of claim 10, wherein a pulley is engaged with said hook.

12. The wire puller of claim 1, wherein said bracket is capable of pivoting outwardly from said plane defined by said first and second supports.

13. The wire puller of claim 1, wherein said capstan extends outwardly from said plane defined by said first and seconds support in a direction substantially opposite to said bracket.

14. The wire puller of claim 1, wherein said capstan is configured to be operated by a drill.

15. A method of pulling a wire through a conduit comprising:
providing a wire puller comprising first and second longitudinally extending supports positioned in a spaced-apart and substantially parallel arrangement, at least one wire guide surface extending between said first and said second supports, at least one capstan support attached to at least one of said first and second supports, at least one capstan attached to said capstan support, at least one hook support extending between said first and second supports, at least one hook engaged with said hook support and a brace attached to said first and second supports;
bracing said wire puller on a wall surface above said conduit by contacting said brace with said wall surface;
engaging a wire or a lead for a wire to said wire puller; and
pulling a wire through said conduit.
